(19) United States
(12) Patent Application Publication
(10) Pub. No.: US 2026/0230529 A1
(43) Pub. Date: Aug. 6, 2026

(54) VEHICLE, INFORMATION PROCESSING APPARATUS, SYSTEM, AND SETTING SELECTION METHOD

(71) Applicant: TOYOTA JIDOSHA KABUSHIKI KAISHA, Toyota-shi (JP)

(72) Inventor: Ayako TAKIZAKI, Okazaki-shi (JP)

(73) Assignee: TOYOTA JIDOSHA KABUSHIKI KAISHA, Toyota-shi (JP)

(21) Appl. No.: 19/467,501

(22) Filed: Feb. 2, 2026

(30) Foreign Application Priority Data
Feb. 6, 2025 (JP) 2025-018754

(51) Int. Cl. H04L 67/12; G07C 5/00; B60K 35/10

(52) U.S. Cl. CPC H04L 67/12; G07C 5/008; B60K 35/10

(57) ABSTRACT

An information processing apparatus in a vehicle includes a communication device configured to communicate with a server apparatus, a memory storing a first setting regarding whether to consent to terms of use, and a processor configured to receive, from the server apparatus via the communication device, a second setting regarding whether to consent to the terms of use, determine whether a difference is present between the first and second settings, when the processor determines that a difference is present between the first and second settings, receive, via an input device on the vehicle, user input selecting one of the first and second settings and, based on the selected setting, determine whether a user consents to the terms of use, and, when the processor determines that the user consents to the terms of use, transmit, to the server apparatus via the communication device, information collected in the vehicle.

### CROSS-REFERENCE TO RELATED APPLICATION

This application claims priority to Japanese Patent Application No. 2025-018754 filed on February 6, 2025. The disclosure of the above-identified application, including the specification, drawings, and claims, is incorporated by reference herein in its entirety.

### BACKGROUND

### 1. Technical Field

The disclosure relates to a vehicle, an information processing apparatus, a system, and a setting selection method.

### 2. Description of Related Art

Japanese Unexamined Patent Application Publication No. 2020-135813 (JP 2020-135813 A) describes an apparatus that displays a screen prompting a user in a vehicle to select whether to consent to the provision of information and, when the user consents to the provision of information, transmits the information to the outside of the vehicle.

### SUMMARY

It is conceivable that a setting regarding whether to consent to the terms of use of an external transmission function is held in both an in-vehicle apparatus and a server apparatus. However, if synchronization between the in-vehicle apparatus and the server apparatus fails due to factors, such as a communication failure, it may not be possible to reflect the user's intention regarding whether to allow transmission of personal information to the outside of the vehicle.

The disclosure provides a technology that can reflect the user's intention regarding whether to allow transmission of information to the outside of a vehicle even when synchronization between an in-vehicle apparatus and a server apparatus fails.

A first aspect of the disclosure is a vehicle configured to communicate with a server apparatus. The vehicle includes a positioning device, a microphone, a camera, a sensor, a nonvolatile memory, an input device, and a computer configured to store, in the nonvolatile memory, a first setting regarding whether to consent to terms of use. The computer is configured to collect two or more types of information among four types of information including location information, audio information, image information, and vehicle information respectively acquired through the positioning device, the microphone, the camera, and the sensor. The computer is configured to receive, from the server apparatus, a second setting regarding whether to consent to the terms of use. The computer is configured to determine whether a difference is present between the first setting stored in the nonvolatile memory and the second setting received from the server apparatus. The computer is configured to, when the computer determines that a difference is present between the first setting and the second setting, receive, via the input device, user input selecting one of the first setting and the second setting and, based on the selected setting, determine whether a user consents to the terms of use. The computer is configured to, when the computer determines that the user consents to the terms of use, transmit the collected two or more types of information to the server apparatus in real time, excluding information of a prohibited type. The computer is prohibited from transmitting the information of the prohibited type to an outside of the vehicle.

A second aspect of the disclosure is an information processing apparatus installed in a vehicle. The information processing apparatus includes a communication device configured to communicate with a server apparatus, a memory storing a first setting regarding whether to consent to terms of use, and a processor. The processor is configured to receive, from the server apparatus via the communication device, a second setting regarding whether to consent to the terms of use. The processor is configured to determine whether a difference is present between the first setting stored in the memory and the second setting received from the server apparatus. The processor is configured to, when the processor determines that a difference is present between the first setting and the second setting, receive user input selecting one of the first setting and the second setting via an input device mounted on the vehicle and, based on the selected setting, determine whether a user consents to the terms of use. The processor is configured to, when the processor determines that the user consents to the terms of use, transmit, via the communication device, information collected in the vehicle to the server apparatus.

In the second aspect, the processor may be configured to, in response to receiving, via the input device, user input changing a setting regarding whether to consent to the terms of use, update the first setting with the changed setting in the memory. When the communication device is available for communication with the server apparatus, the processor may be configured to transmit a request to update the second setting with the changed setting to the server apparatus via the communication device.

In the second aspect, the processor may be configured to, when the communication device is first available for communication with the server apparatus after startup, receive the second setting from the server apparatus via the communication device.

In the second aspect described above, the processor may be configured to, when the processor determines that a difference is present between the first setting and the second setting at a time point, ask the user which setting to select, via an output device mounted on the vehicle. The processor may be configured to, in response to receiving, via the input device, not only user input selecting one of the settings but also user input requesting that the same selection be applied when a difference is present between the first setting and the second setting after the time point, apply the same selection without asking the user which setting to select even when the processor determines that a difference is present between the first setting and the second setting after the time point.

In the second aspect, the processor may be configured to transmit, to the server apparatus via the communication device, a request to update the second setting with the first setting when the first setting is selected,. The processor may be configured to, when the second setting is selected, update the first setting with the second setting in the memory.

In the second aspect, the processor may be configured to determine, based on any one of the settings, whether the user consents to the terms of use, when the processor determines that no difference is present between the first setting and the second setting,.

In the second aspect described above, each of the first setting and the second setting may include a setting regarding a type of information prohibited from being transmitted to an outside of the vehicle. The processor may be configured to, when the processor determines that a difference is present between the first setting and the second setting, identify, as a prohibited type based on a selected setting, the type of information prohibited by the user from being transmitted to the outside of the vehicle. The processor may be configured to, when the processor determines that the user consents to the terms of use, transmit information collected in the vehicle, to the server apparatus via the communication device, excluding information of the identified prohibited type.

In the second aspect mentioned, the processor may be configured to, in response to receiving user input designating the prohibited type via the input device, add a setting regarding the prohibited type to the first setting in the memory. When the communication device is available for communication with the server apparatus, the processor may be configured to transmit, to the server apparatus via the communication device, a request to add the setting regarding the prohibited type to the second setting.

In the second aspect, the processor may be configured to, when the processor determines that no difference is present between the first setting and the second setting, identify the prohibited type based on any one of the settings.

In the second embodiment, the information collected by the vehicle may include two or more types of information among four types of information including location information, audio information, image information, and vehicle information respectively acquired through a positioning device, a microphone, a camera, and a sensor mounted on the vehicle.

A third aspect of the disclosure is a system. The system includes the information processing apparatus and the server apparatus.

In the third aspect, the server apparatus may be configured to, in response to receiving a request to change a setting regarding whether to consent to the terms of use from a terminal apparatus associated with the user, update the second setting according to the received request.

A fourth aspect of the disclosure is a vehicle that includes the information processing apparatus.

A fifth aspect of the disclosure is a setting selection method that is executed by a processor of an information processing apparatus installed in a vehicle, the information processing apparatus including a communication device configured to communicate with a server apparatus, a memory storing a first setting regarding whether to consent to terms of use, and the processor. The setting selection method includes receiving, from the server apparatus via the communication device, a second setting regarding whether to consent to the terms of use; determining whether a difference is present between the first setting stored in the memory and the second setting received from the server apparatus; when the processor determines that a difference is present between the first setting and the second setting, receiving user input selecting one of the first setting and the second setting and, based on the selected setting via an input device mounted on the vehicle, determining whether a user consents to the terms of use; and, when the processor determines that the user consents to the terms of use, transmitting, via the communication device, information collected in the vehicle to the server apparatus.

In the fifth aspect, the setting selection method may include, in response to receiving, via the input device, user input changing a setting regarding whether to consent to the terms of use, updating the first setting with the changed setting in the memory. When the communication device is allowed to communicate with the server apparatus, the setting selection method may include transmitting a request to update the second setting with the changed setting to the server apparatus via the communication device.

In the fifth aspect, the setting selection method may include, when the communication device is first available for communication with the server apparatus after startup of the processor, receiving the second setting from the server apparatus via the communication device.

In the fifth aspect, the setting selection method may include, when the processor determines that a difference is present between the first setting and the second setting at a time point, asking the user which setting to select, via an output device mounted on the vehicle. The setting selection method may include, in response to receiving, via the input device, not only user input selecting one of the settings but also user input requesting that the same selection be applied when a difference is present between the first setting and the second setting after the time point, applying the same selection without asking the user which setting to select even when the processor determines that a difference is present between the first setting and the second setting after the time point.

In the fifth aspect, the setting selection method may include, when the processor determines that a difference is present between the first setting and the second setting, identifying, as a prohibited type based on a selected setting, ae type of information prohibited by the user from being transmitted to an outside of the vehicle. The setting selection method may include, when the processor determines that the user consents to the terms of use, transmitting information collected in the vehicle to the server apparatus via the communication device, excluding information of the identified prohibited type. Each of the first setting and the second setting may include a setting regarding the type of information prohibited from being transmitted to the outside of the vehicle.

In the fifth aspect, the setting selection method may include, in response to receiving user input designating the prohibited type via the input device, adding a setting regarding the prohibited type to the first setting in the memory. When the communication device is available for communication with the server apparatus, the setting selection method may include transmitting, to the server apparatus via the communication device, a request to add the setting regarding the prohibited type to the second setting.

According to the first aspect, second aspect, third aspect, fourth aspect, and fifth aspect of the disclosure, it is possible to reflect the user's intention regarding whether to allow transmission of information to an outside of a vehicle even when synchronization between an in-vehicle apparatus and a server apparatus fails.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram that shows the configuration of a system according to an embodiment of the disclosure;

FIG. 2 is a diagram that shows an example of a vehicle equipped with an information processing apparatus according to the embodiment of the disclosure;

FIG. 3 is a block diagram that shows connections between an in-vehicle device and the information processing apparatus according to the embodiment of the disclosure;

FIG. 4 is a sequence diagram that shows an example of a communication procedure between the information processing apparatus according to the embodiment of the disclosure and a server apparatus;

FIG. 5 is a flowchart that shows the operation of the information processing apparatus according to the embodiment of the disclosure; and

FIG. 6 is a flowchart that shows the additional operation of the information processing apparatus according to the embodiment of the disclosure.

### DETAILED DESCRIPTION OF EMBODIMENTS

Hereinafter, an embodiment of the disclosure will be described with reference to the accompanying drawings.

Like reference signs denote the same or corresponding portions in the drawings. In the description of the present embodiment, the description of the same or corresponding portions is omitted or simplified as needed.

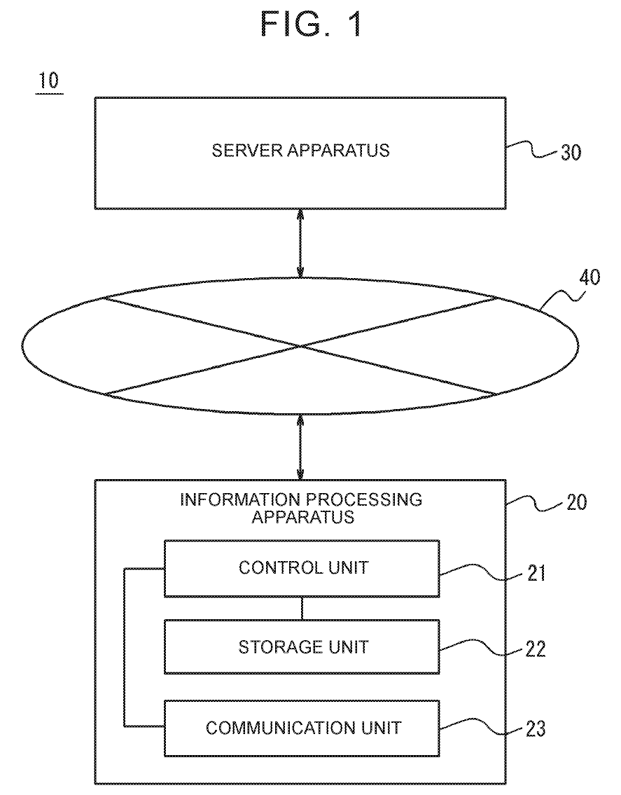

The configuration of a system 10 according to the present embodiment will be described with reference to FIG. 1.

The system 10 according to the present embodiment includes an information processing apparatus 20 and a server apparatus 30. The information processing apparatus 20 is capable of communicating with the server apparatus 30 via a network 40.

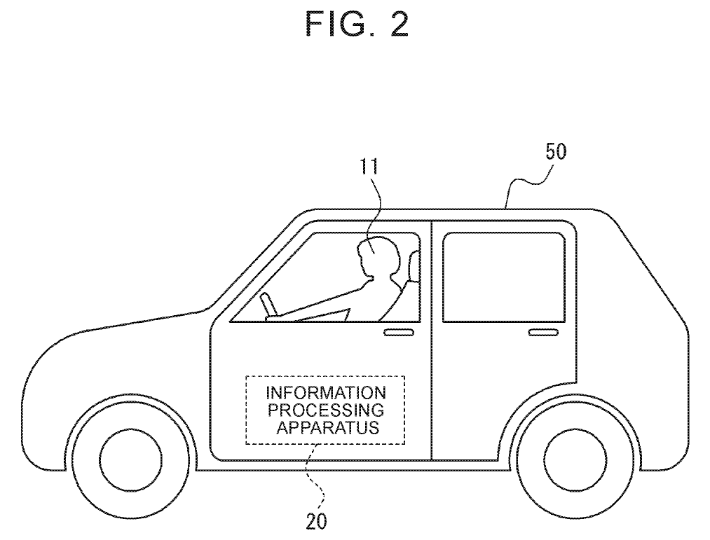

The information processing apparatus 20 is a computer, such as a microcomputer and an ECU, or an apparatus that is a combination of such a computer with another device, such as a communication device. "ECU” is an abbreviation for electronic control unit. As shown in FIG. 2, the information processing apparatus 20 is installed in a vehicle 50.

The vehicle 50 is any type of vehicle, such as a gasoline vehicle, a diesel vehicle, a hydrogen vehicle, an HEV, a PHEV, a BEV, and an FCEV. "HEV” is an abbreviation for hybrid electric vehicle. "PHEV” is an abbreviation for plug-in hybrid electric vehicle. "BEV” is an abbreviation for battery electric vehicle. "FCEV” is an abbreviation for fuel cell electric vehicle. The vehicle 50 is driven by a user 11 in the present embodiment. Alternatively, the vehicle 50 may be automatically driven at a selected level. The level of automation is, for example, any one of level 1 to level 5 in SAE-defined levels. "SAE” is an abbreviation for Society of Automotive Engineers. The vehicle 50 may be a MaaS-dedicated vehicle. "MaaS” is an abbreviation for Mobility as a Service.

The server apparatus 30 is a server computer, such as a cloud server. The server apparatus 30 is installed in a facility, such as a data center.

The network 40 includes the Internet, at least one WAN, at least one MAN, or any combination of them. "WAN” is an abbreviation for wide area network. "MAN” is an abbreviation for metropolitan area network. The network 40 may include at least one wireless network, at least one optical network, or a combination of them. Examples of the wireless network include an ad hoc network, a cellular network, a wireless LAN, a satellite communication network, and a terrestrial microwave network. "LAN” is an abbreviation for local area network.

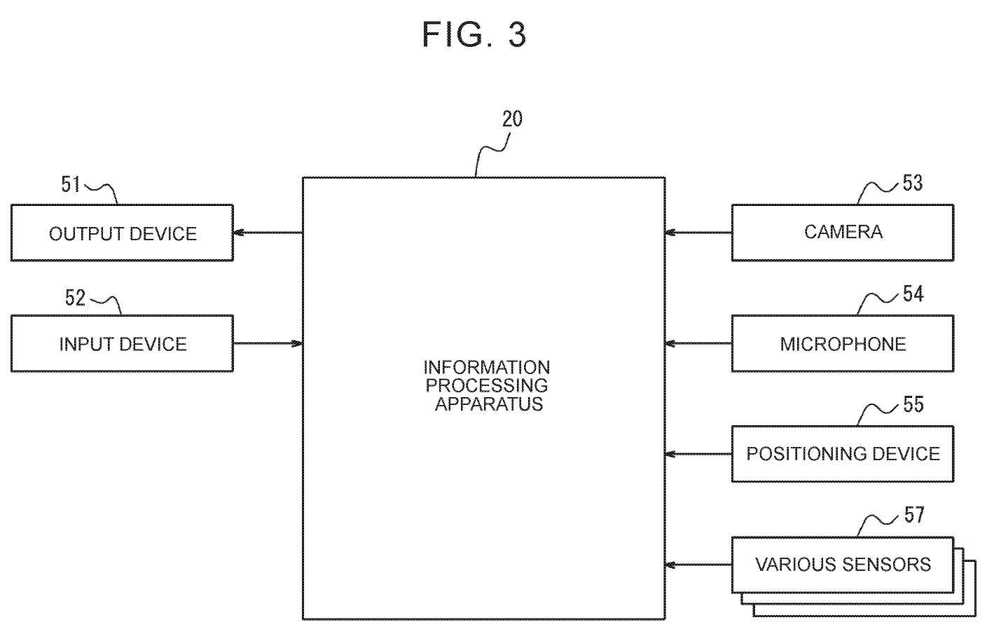

As shown in FIG. 3, in the present embodiment, the information processing apparatus 20 is connected to various devices mounted on the vehicle 50. The various devices include an output device 51, an input device 52, a camera 53, a microphone 54, a positioning device 55, various sensors 57, and the like. Interfaces that support standards, such as USB, HDMI (registered trademark), and Bluetooth (registered trademark), can be used as the interfaces for connecting to various devices. "USB” is an abbreviation for Universal Serial Bus. "HDMI (registered trademark)” is an abbreviation for High-Definition Multimedia Interface. The information processing apparatus 20 may be connected to various devices via an in-vehicle network, such as a CAN. "CAN” is an abbreviation for Controller Area Network. In a modification, the information processing apparatus 20 may include one or more of the various devices mounted on the vehicle 50.

The output device 51 is, for example, a display or a speaker. The display is, for example, an LCD or an organic EL display. "LCD” is an abbreviation for liquid crystal display. "EL" is an abbreviation for electro luminescent. The display may also be a display audio. The output device 51 outputs information obtained through the operation of the information processing apparatus 20.

The input device 52 is, for example, a physical key, a capacitance key, a pointing device, or a touch screen provided integrally with a display. The camera 53, the microphone 54, or both may also serve as the input device 52. The input device 52 receives an operation to input information used in the operation of the information processing apparatus 20.

The camera 53 is, for example, a visible light camera or a depth camera. The camera 53 captures images of the inside, outside, or both of the vehicle 50. The camera 53 outputs image information that includes the captured images.

The microphone 54 collects sound from inside, outside, or both of the vehicle 50. The microphone 54 outputs audio information that includes the collected sound.

The positioning device 55 is, for example, a GNSS receiver. "GNSS" is an abbreviation for global navigation satellite system. GNSS is, for example, GPS, QZSS, BDS, GLONASS, or Galileo. "GPS” is an abbreviation of Global Positioning System. "QZSS” is an abbreviation of Quasi-Zenith Satellite System. The satellites of QZSS are called quasi-zenith satellites. "BDS” is an abbreviation for BeiDou Navigation Satellite System. "GLONASS” is an abbreviation for Global Navigation Satellite System. The positioning device 55 measures the coordinates of the vehicle 50, that is, the vehicle location. The positioning device 55 outputs location information that includes the measured vehicle location.

The various sensors 57 include, for example, a vehicle speed sensor, an acceleration sensor, a gyro, a motion sensor, and a door open-close sensor. The various sensors 57 observe different events at respective portions the vehicle 50. The various sensors 57 output vehicle information that includes the results of observations.

The outline of the present embodiment will be described with reference to FIG. 1 to FIG. 3.

The vehicle 50 is capable of communicating with the external server apparatus 30. As described above, the vehicle 50 includes a computer or the information processing apparatus 20 that includes a computer.

The information processing apparatus 20 stores, in a nonvolatile memory, a first setting regarding whether to consent to the terms of use. The information processing apparatus 20 receives, from the server apparatus 30 via the network 40, a second setting regarding whether to consent to the terms of use. The information processing apparatus 20 determines whether there is a difference between the first setting stored in the nonvolatile memory and the second setting received from the server apparatus 30. When the information processing apparatus 20 determines that there is a difference between the first setting and the second setting, the information processing apparatus 20 receives, via an input device 52 mounted on the vehicle 50, user input selecting one of the first setting and the second setting and, based on the selected setting, determines whether the user 11 has consented to the terms of use. When the information processing apparatus 20 determines that the user 11 has consented to the terms of use, the information processing apparatus 20 transmits information collected in the vehicle 50 to the server apparatus 30 via the network 40.

According to the present embodiment, even when synchronization between the information processing apparatus 20 and the server apparatus 30 fails due to factors, such as a communication failure, it is possible to reflect the intention of the user 11 regarding whether to allow transmission of information to the outside of the vehicle 50. For example, if one of the settings is uniquely determined to be adopted when synchronization between the information processing apparatus 20 and the server apparatus 30 fails, it may not be able to handle personal information according to the intention of the user 11. However, in the present embodiment, such a situation can be avoided.

In the present embodiment, the information processing apparatus 20 collects four types of information including location information, audio information, image information, and vehicle information respectively acquired through the positioning device 55, the microphone 54, the camera 53, and the various sensors 57 mounted on the vehicle 50. When the information processing apparatus 20 determines that the user 11 has consented to the terms of use, the information processing apparatus 20 transmits the collected four types of information to the server apparatus 30 in real time, excluding information of a prohibited type that is a type of information to be prohibited by the user 11 from being transmitted to the outside of the vehicle 50.

In a modification, the information processing apparatus 20 may collect only three types of information from among the four types of information. In this modification, when the information processing apparatus 20 determines that the user 11 has consented to the terms of use, the information processing apparatus 20 transmits the collected three types of information to the server apparatus 30 in real time, excluding information of the prohibited type.

In another modification, the information processing apparatus 20 may collect only two types of information from among the four types of information. In this modification, when the information processing apparatus 20 determines that the user 11 has consented to the terms of use, the information processing apparatus 20 transmits the collected two types of information to the server apparatus 30 in real time, excluding information of the prohibited type.

In the present embodiment, as part of the efforts to protect personal information, privacy settings are held on both the information processing apparatus 20 and the server apparatus 30, and the information processing apparatus 20 and the server apparatus 30 synchronize the privacy settings. The privacy settings include the status of consent to the terms of use and whether transmission of personal information to the outside of the vehicle 50 is allowed. Personal information is managed in units of location information, audio information, image information, and all personal information including these pieces of information, and transmission to the outside of the vehicle 50 is performed or stopped based on the settings of the user 11. Vehicle information is included in "all personal information”.

When privacy settings are changed in places with poor communication environments, such as underground parking areas, communication may fail, so there can be a difference in values between the information processing apparatus 20 and the server apparatus 30. Privacy settings are desired to accurately reflect the intension of the user 11. Therefore, in the present embodiment, when there occurs the difference, the information processing apparatus 20 promptly notifies the user 11 and allows the user 11 to select which value to use.

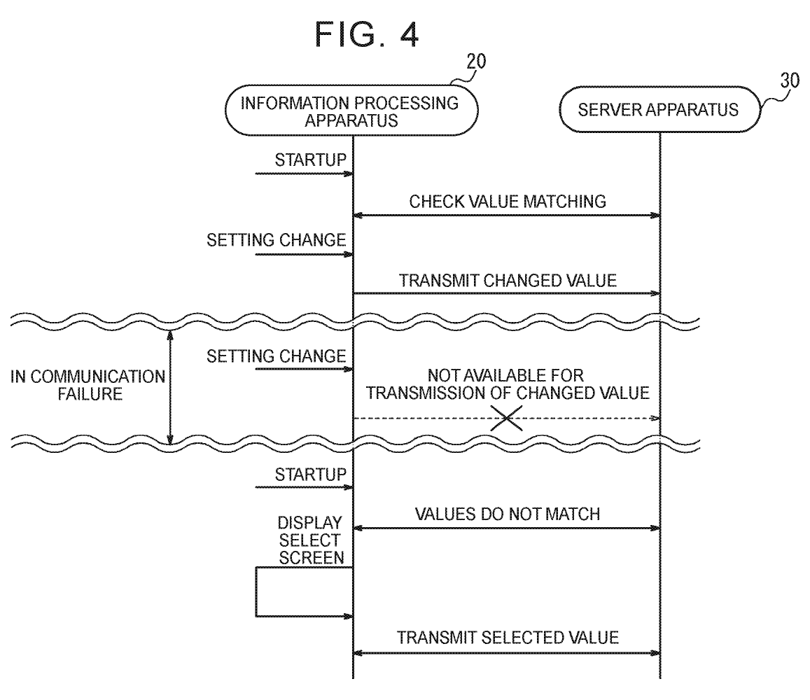

FIG. 4 shows an example of the communication procedure between the information processing apparatus 20 and the server apparatus 30.

In this example, the information processing apparatus 20 checks at startup whether the values of privacy settings in the information processing apparatus 20 and the values of privacy setting in the server apparatus 30 match with each other. Among the privacy settings, the initial value regarding the status of consent to the terms of use is "not consented”, and the initial value regarding whether transmission of location information to the outside of the vehicle 50, the initial value regarding whether transmission of audio information to the outside of the vehicle 50, the initial value regarding whether transmission of image information to the outside of the vehicle 50, and the initial value regarding whether transmission of all personal information to the outside of the vehicle 50 are all “not allowed”. Therefore, at the initial startup, the values of privacy settings in the information processing apparatus 20 and the values of privacy settings in the server apparatus 30 match with each other.

The information processing apparatus 20 transmits the changed values of privacy settings to the server apparatus 30 at the time of a setting change. A setting change is performed through the display mounted on the vehicle 50.

For example, a screen that contains the text of the terms of use and a user interface for selecting “consent" or “non-consent" is displayed on the display. When “consent” is selected at the time of the first setting change, the value regarding the status of consent to the terms of use is changed from “not consented” to “consented”. When “non-consent” is selected at the first setting change, the value regarding the status of consent to the terms of use is changed from “not consented” to “non-consent”. At the time of the second and subsequent setting changes, when “non-consent” is selected last time and “consent” is selected this time, the value regarding the status of consent to the terms of use is changed from “non-consent” to “consented”. At the time of the second and subsequent setting changes, when “consent” is selected last time and “non-consent” is selected this time, the value regarding the status of consent to the terms of use is changed from “consented” to “non-consent”.

At the time of any setting change, when “consent" is selected, a screen containing a list including four items, that is, location information, audio information, image information, and all personal information, and a user interface for selecting “allowed” or “not allowed” for each item is displayed on the display. When “allowed" is selected for the “not allowed” item, the value regarding whether to allow transmission of information corresponding to that item to the outside of the vehicle 50 is changed from “not allowed" to “allowed”. When “not allowed" is selected for the “allowed” item, the value regarding whether to allow transmission of information corresponding to that item to the outside of the vehicle 50 is changed from “allowed" to “not allowed”.

When the information processing apparatus 20 is in communication failure at the time of a setting change, the information processing apparatus 20 cannot transmit the changed values of privacy settings to the server apparatus 30. As a result, at the next startup, the values of privacy settings in the information processing apparatus 20 and the values of privacy settings in the server apparatus 30 do not match with each other.

When there occurs a difference in the values of privacy settings between the information processing apparatus 20 and the server apparatus 30, the information processing apparatus 20 displays a select screen, on the display, asking which value to select. The information processing apparatus 20 reflects the selected values in both the information processing apparatus 20 and the server apparatus 30.

For example, when there occurs a difference in the value regarding the status of consent to the terms of use, a first select screen including a user interface for selecting “consent" or “non-consent” is displayed on the display. On the first select screen, the text of the terms of use may be additionally displayed. When “consent" is selected, the value regarding the status of consent to the terms of use for the one that is not “consented" between the information processing apparatus 20 and the server apparatus 30 is changed to “consented”. When “non-consent" is selected, the value regarding the status of consent to the terms of use for the one that is not “non-consent" between the information processing apparatus 20 and the server apparatus 30 is changed to “non-consent”.

On the first select screen, a checkbox indicating that "Adopt this selection again when a similar situation occurs in the future" may be further displayed. When this checkbox is checked, the first select screen is not displayed even when a similar situation occurs later, and the current selection is reflected again. With this configuration, when a communication failure frequently occurs at startup, such as when the vehicle 50 is parked in a parking area every day, it is possible to at least partially prevent the user 11 from feeling annoyed by the first select screen being displayed multiple times.

For example, when there occurs a difference in value regarding whether to allow transmission of personal information to the outside of the vehicle 50, a second select screen containing a list including four items, that is, location information, audio information, image information, and all personal information, and a user interface for selecting “allowed" or “not allowed" for each item is displayed on the display. In the second select screen, items with no difference in value between the information processing apparatus 20 and the server apparatus 30 do not need to be displayed. When “allowed" is selected for the “not allowed” item, the value regarding whether to allow transmission of information corresponding to that item to the outside of the vehicle 50 on the side not changed to “allowed” between the information processing apparatus 20 and the server apparatus 30 is changed to “allowed”. When “not allowed" is selected for the “allowed” item, the value regarding whether to allow transmission of information corresponding to that item to the outside of the vehicle 50 on the side not changed to “not allowed” between the information processing apparatus 20 and the server apparatus 30 is changed to “not allowed”.

On the second select screen, a checkbox indicating that "Adopt this selection again when a similar situation occurs in the future" may be further displayed.

When this checkbox is checked, the second select screen is not displayed even when a similar situation occurs later, and the current selection is reflected again. With this configuration, when a communication failure frequently occurs at startup, such as when the vehicle 50 is parked in a parking area every day, it is possible to at least partially prevent the user 11 from feeling annoyed by the second select screen being displayed multiple times.

The configuration of the information processing apparatus 20 according to the present embodiment will be described with reference to FIG. 1.

The information processing apparatus 20 includes a control unit 21, a storage unit 22, and a communication unit 23.

The control unit 21 includes at least one processor, at least one programmable circuit, at least one dedicated circuit, or any combination of them. The processor is, for example, a general-purpose processor, such as a CPU and a GPU, or a special-purpose processor specialized in a specific process. "CPU” is an abbreviation for central processing unit. "GPU” is an abbreviation for graphics processing unit. The programmable circuit is, for example, an FPGA. "FPGA” is an abbreviation for field-programmable gate array. The dedicated circuit is, for example, an ASIC. "ASIC" is an abbreviation for application specific integrated circuit. The control unit 21 executes a process related to the operation of the information processing apparatus 20 while controlling the units of the information processing apparatus 20.

The storage unit 22 includes at least one semiconductor memory, at least one magnetic memory, at least one optical memory, or any combination of them. The semiconductor memory is, for example, a RAM, a ROM, or a flash memory. "RAM” is an abbreviation for random access memory. "ROM” is an abbreviation for read only memory. The RAM is, for example, an SRAM or a DRAM. "SRAM” is an abbreviation for static random access memory. "DRAM” is an abbreviation for dynamic random access memory. The ROM is, for example, an EEPROM. "EEPROM” is an abbreviation for electrically erasable programmable read only memory. The flash memory is, for example, an SSD. "SSD” is an abbreviation for solid-state drive. The magnetic memory is, for example, an HDD. "HDD” is an abbreviation for hard disk drive. The storage unit 22 functions as, for example, a main storage device, an auxiliary storage device, or a cache memory. The storage unit 22 stores information used in the operation of the information processing apparatus 20 and information obtained through the operation of the information processing apparatus 20.

In the present embodiment, the storage unit 22 includes a nonvolatile memory that stores privacy settings as a first setting regarding whether to consent to the terms of use.

The communication unit 23 includes at least one communication module. The communication module is, for example, a module that supports a mobile communication standard, such as LTE, 4G standard, and 5G standard, or a wireless LAN communication standard, such as IEEE 802.11. "LTE” is an abbreviation for Long Term Evolution. "4G” is an abbreviation for 4th generation. "5G” is an abbreviation for 5th generation. "IEEE” is an abbreviation for Institute of Electrical and Electronics Engineers. The communication unit 23 communicates with the server apparatus 30. The communication unit 23 receives information used in the operation of the information processing apparatus 20 and transmits information obtained through the operation of the information processing apparatus 20.

The functions of the information processing apparatus 20 are implemented by the processor, that is, the control unit 21, running a program according to the present embodiment. In other words, the functions of the information processing apparatus 20 are implemented by software. The program causes a computer to function as the information processing apparatus 20 by causing the computer to execute the operation of the information processing apparatus 20. In other words, the computer executes the operation of the information processing apparatus 20 in accordance with the program to function as the information processing apparatus 20.

The program can be stored in a non-transitory computer-readable medium. The non-transitory computer-readable medium is, for example, a flash memory, a magnetic recording device, an optical disc, a magneto-optical recording medium, or a ROM. The program is distributed by, for example, selling, transferring, or lending a portable medium, such as an SD card, a DVD, and a CD-ROM, in which the program is stored. "SD" is an abbreviation for Secure Digital. "DVD” is an abbreviation for digital versatile disc. "CD-ROM" is an abbreviation for compact disc read only memory. Alternatively, the program may be distributed by storing the program in a storage of a server and transferring the program from the server to another computer. Alternatively, the program may be provided as a program product.

A computer, for example, once stores, in a main storage device, a program stored in a portable medium or transferred from a server. Then, the computer causes a processor to read the program stored in the main storage device and executes a process according to the read program on the processor. The computer may directly read the program from the portable medium and execute a process according to the program. Each time the program is transferred from a server to the computer, the computer may occasionally execute a process according to the received program. The program may be executed by a so-called ASP service in which the program is not transferred from a server to the computer and a function is implemented only by providing an execution instruction and acquiring a result. "ASP” is an abbreviation for application service provider. The program includes information subjected to a process on an electronic computer and similar to a program. For example, data that is not a direct command to a computer and that has a property of defining a process of the computer corresponds to “information similar to a program”.

One or some or all of the functions of the information processing apparatus 20 may be implemented by a programmable circuit or a dedicated circuit serving as the control unit 21. In other words, one or some or all of the functions of the information processing apparatus 20 may be implemented by hardware.

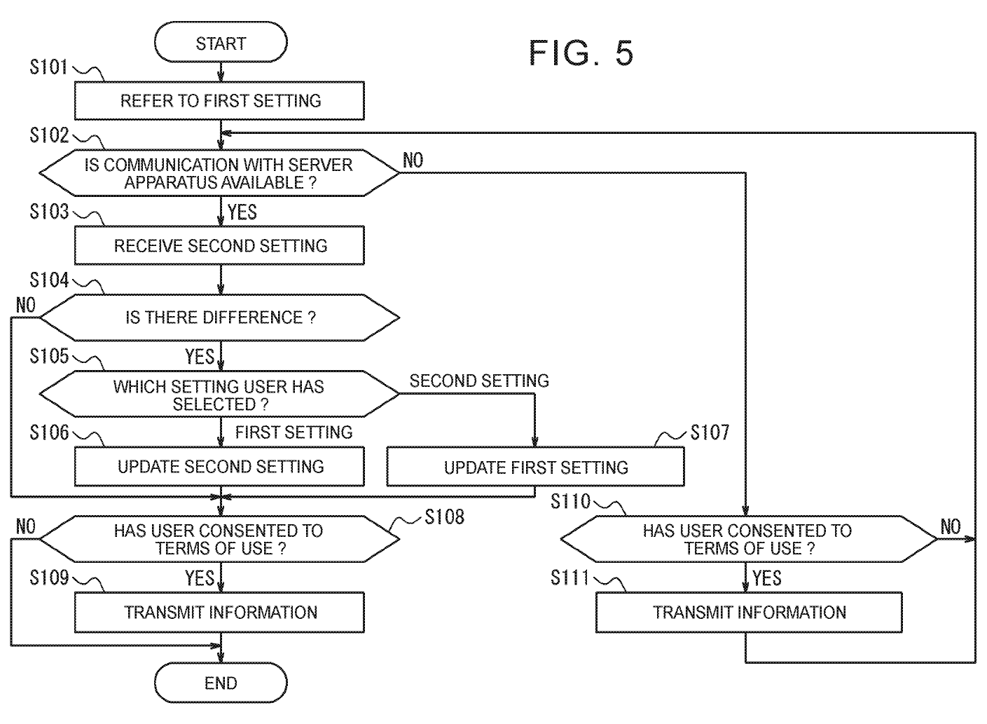

The operation of the information processing apparatus 20 according to the present embodiment will be described with reference to FIG. 5. The operation described below is an example of a setting selection method according to the present embodiment. In other words, the setting selection method according to the present embodiment may include step S101, step S102, step S103, step S104, step S105, step S106, step S107, step S108, step S109, step S110, and step S111 shown in FIG. 5.

In S101, the control unit 21 refers to the first setting regarding whether to consent to the terms of use stored in the storage unit 22. For example, the control unit 21 refers to the values of privacy settings stored in the nonvolatile memory. After S101, step S102 is executed.

In S102, the control unit 21 determines whether communication with the server apparatus 30 is available. Specifically, the control unit 21 checks the availability of connection to the network 40 via the communication unit 23, and transmits a request to the server apparatus 30 through the network 40 to check for a response from the server apparatus 30. When a connection to the network 40 is available and the control unit 21 has received a response from the server apparatus 30, the control unit 21 determines that the communication unit 23 is available for communication with the server apparatus 30. In other cases, the control unit 21 determines that the communication unit 23 is not available for communication with the server apparatus 30. When the control unit 21 determines that the communication unit 23 is available for communication with the server apparatus 30, step S103 is executed. On the other hand, when the control unit 21 determines that the communication unit 23 is not available for communication with the server apparatus 30, step S110 is executed.

In S103, the control unit 21 receives, from the server apparatus 30 via the communication unit 23, the second setting regarding whether to consent to the terms of use. For example, the control unit 21 receives the values of privacy settings from the server apparatus 30 via the communication unit 23. After S103, step S104 is executed.

In step S104, the control unit 21 determines whether there is a difference between the first setting referred to in S101 and the second setting received in S103. For example, the control unit 21 compares the value regarding the status of consent to the terms of use, included in the values of privacy settings referred to in S101, with the value regarding the status of consent to the terms of use, included in the values of privacy settings received in S103. When both values are "not consented”, or both values are “consented”, or both values are “non-consent”, the control unit 21 determines that there is no difference between the first setting and the second setting. In other cases, the control unit 21 determines that there is a difference between the first setting and the second setting.

In the present embodiment, the first setting and the second setting each include a setting regarding types of information to be prohibited from being transmitted to the outside of the vehicle 50. For example, the control unit 21 compares the value regarding whether to allow transmission of personal information to the outside of the vehicle 50, included in the values of privacy settings referred to in S101, with the value regarding whether to allow transmission of personal information to the outside of the vehicle 50, included in the values of privacy settings received in S103, for each type of personal information. When both values are “not allowed” or both values are “allowed” for any of location information, audio information, image information, and all personal information, the control unit 21 determines that there is no difference between the first setting and the second setting. In other cases, the control unit 21 determines that there is a difference between the first setting and the second setting.

When the control unit 21 determines in S104 that there is a difference between the first setting and the second setting, step S105 is executed. On the other hand, when the control unit 21 determines that there is no difference between the first setting and the second setting, step S108 is executed.

In S105, the control unit 21 receives, via the input device 52, user input selecting one of the first setting and the second setting. For example, the control unit 21 displays the first select screen on the display and receives, via the touch screen, touch input selecting “consent" or “non-consent”.

In the present embodiment, as described above, the first setting and the second setting each include a setting regarding types of information to be prohibited from being transmitted to the outside of the vehicle 50. For example, when the control unit 21 determines in S104 that there is a difference in the value regarding whether to allow transmission of personal information to the outside of the vehicle 50, the control unit 21 displays the second select screen on the display and receives, via the touch screen, touch input selecting “allowed" or “not allowed" for each item. The control unit 21 may receive touch input selecting “allowed" or “not allowed" only for items with differences in value.

When the first setting is selected in S105, step S106 is executed. On the other hand, when the second setting is selected, step S107 is executed.

In S106, the control unit 21 transmits, to the server apparatus 30 via the communication unit 23, a request to update the second setting with the first setting. In response to receiving a request, the server apparatus 30 updates the second setting with the first setting according to the received request. For example, the server apparatus 30 updates the held values of privacy settings so as to match with the values of privacy settings stored in the nonvolatile memory of the information processing apparatus 20. After S106, step S108 is executed.

In step S107, the control unit 21 updates the first setting with the second setting in the storage unit 22. For example, the control unit 21 updates the values of privacy settings stored in the nonvolatile memory so as to match with the values of privacy settings held by the server apparatus 30. After S107, step S108 is executed.

When the control unit 21 determines in S104 that there is a difference between the first setting and the second setting, the control unit 21 determines in S108, based on the setting selected in S105, whether the user 11 has consented to the terms of use. When the control unit 21 determines in S104 that there is no difference between the first setting and the second setting, the control unit 21 determines, based on any one of the settings, whether the user 11 has consented to the terms of use. For example, when both the value regarding the status of consent to the terms of use, included in the values of privacy settings to which “consent” is selected in S105 or referred to in S101 and the value regarding the status of consent to the terms of use, included in the values of privacy settings, received in S103, are “consented”, the control unit 21 determines that the user 11 has consented to the terms of use. In other cases, the control unit 21 determines that the user 11 has not consented to the terms of use.

In the present embodiment, as described above, the first setting and the second setting each include a setting regarding types of information to be prohibited from being transmitted to the outside of the vehicle 50. When the control unit 21 determines in S104 that there is a difference between the first setting and the second setting, the control unit 21 identifies the types of information to be prohibited by the user 11 from being transmitted to the outside of the vehicle 50 as prohibited types based on the setting selected in S105. When the control unit 21 determines in S104 that there is no difference between the first setting and the second setting, the control unit 21 identifies the prohibited types based on any one of the first setting and the second setting. For example, the control unit 21 identifies the items for which “not allowed” is selected in S105 or the items for which both the value regarding whether to allow transmission of personal information to the outside of the vehicle 50, included in the items of privacy settings referred to in S101, and the value regarding whether to allow transmission of personal information to the outside of the vehicle 50, included in the values of privacy settings received in S103, are “not allowed” as prohibited types.

When the control unit 21 determines in S108 that the user 11 has consented to the terms of use, step S109 is executed. On the other hand, when the control unit 21 determines that the user 11 has not consented to the terms of use, the flow shown in FIG. 5 ends.

In S109, the control unit 21 transmits information collected in the vehicle 50 to the server apparatus 30 via the communication unit 23. Specifically, the control unit 21 transmits four types of information, including location information, audio information, image information, and vehicle information, respectively acquired through the positioning device 55, the microphone 54, the camera 53, and the various sensors 57, to the server apparatus 30 via the communication unit 23. In a modification, the control unit 21 may transmit only three types of information from among the four types of information to the server apparatus 30 via the communication unit 23. In another modification, the control unit 21 may transmit only two types of information from among the four types of information to the server apparatus 30 via the communication unit 23.

In the present embodiment, as described above, the first setting and the second setting each include a setting regarding types of information to be prohibited from being transmitted to the outside of the vehicle 50. When the control unit 21 determines in S108 that the user 11 has consented to the terms of use, the control unit 21 transmits information collected in the vehicle 50 to the server apparatus 30 via the communication unit 23, excluding information of the prohibited types identified in S108.

After S109, the flow shown in FIG. 5 ends.

In S110, the control unit 21 determines whether the user 11 has consented to the terms of use based on the first setting referred to in S101. For example, when the value regarding the status of consent to the terms of use, included in the values of privacy settings referred to in S101 is “consented”, the control unit 21 determines that the user 11 has consented to the terms of use. In other cases, the control unit 21 determines that the user 11 has not consented to the terms of use.

In the present embodiment, as described above, the first setting includes a setting regarding types of information to be prohibited from being transmitted to the outside of the vehicle 50. The control unit 21 identifies the prohibited types based on the first setting. For example, the control unit 21 identifies the items for which the value regarding whether to allow transmission of personal information to the outside of the vehicle 50, included in the values of privacy settings referred to in S101, is “not allowed” as prohibited types.

When the control unit 21 determines in S110 that the user 11 has consented to the terms of use, step S111 is executed. On the other hand, when the control unit 21 determines that the user 11 has not consented to the terms of use, step S102 is executed again. Then, after the ignition of the vehicle 50 is turned on, at the time point when the communication unit 23 first becomes available for communication with the server apparatus 30, step S103 is executed. In other words, the control unit 21 receives the second setting from the server apparatus 30 via the communication unit 23 at the time point when the communication unit 23 first becomes available for communication with the server apparatus 30 after startup.

In S111, the control unit 21 transmits information collected in the vehicle 50 to the server apparatus 30 via the communication unit 23. Specifically, the control unit 21 transmits four types of information, including location information, audio information, image information, and vehicle information, respectively acquired through the positioning device 55, the microphone 54, the camera 53, and the various sensors 57, to the server apparatus 30 via the communication unit 23. In a modification, the control unit 21 may transmit only three types of information from among the four types of information to the server apparatus 30 via the communication unit 23. In another modification, the control unit 21 may transmit only two types of information from among the four types of information to the server apparatus 30 via the communication unit 23.

In the present embodiment, as described above, the first setting includes a setting regarding types of information to be prohibited from being transmitted to the outside of the vehicle 50. When the control unit 21 determines in S110 that the user 11 has consented to the terms of use, the control unit 21 transmits information collected in the vehicle 50 to the server apparatus 30 via the communication unit 23, excluding information of the prohibited types identified in S110.

After S111, step S102 is executed again. Then, after the ignition of the vehicle 50 is turned on, at the time point when the communication unit 23 first becomes available for communication with the server apparatus 30, step S103 is executed. In other words, the control unit 21 receives the second setting from the server apparatus 30 via the communication unit 23 at the time point when the communication unit 23 first becomes available for communication with the server apparatus 30 after startup.

In S109 and S111, information collected in the vehicle 50 may be transmitted to the server apparatus 30 in association with various additional information. The additional information includes, for example, the identifier of the user 11, the identifier of the vehicle 50, or both, the time when the information is acquired, the driving situation of the vehicle 50 when the information is acquired, or the type of information acquired. The information transmitted to the server apparatus 30 can be used by a business operator that operates the server apparatus 30, together with the additional information. Alternatively, the information transmitted to the server apparatus 30 may be provided secondarily to a third party by a business operator that operates the server apparatus 30, together with the additional information or with some of the additional information concealed, and can be used by the third party.

In a modification, when the control unit 21 determines that there is a difference between the first setting and the second setting at a certain time point PT, the control unit 21 may ask, via the output device 51, the user 11 which setting to select. In this modification, when the control unit 21 receives not only user input selecting one of the settings via the input device 52 but also user input requesting that the same selection be applied when there is a difference between the first setting and the second setting after the time point PT, the control unit 21 applies the same selection even when the control unit 21 determines that there is a difference between the first setting and the second setting after the time point PT, without asking the user 11 which setting to select. For example, in S105, the control unit 21 may further display, on the display, a checkbox indicating that "Adopt this selection when a similar situation occurs in the future”. When this checkbox is checked, the select screen is not displayed again even when step S105 is executed again, and this selection is reflected again.

In a modification, the user 11 may be able to designate whether to allow transmission of personal information from the vehicle 50 to the server apparatus 30 not only through the information processing apparatus 20 but also through a different route. The “different route" refers to, for example, an application installed on a terminal apparatus associated with the user 11, or a website. The terminal apparatus is, for example, a mobile device or a PC. Examples of the mobile device include a mobile phone, a smartphone, and a tablet. "PC” is an abbreviation for personal computer. In this modification, the server apparatus 30 receives, from the terminal apparatus, a request to change the setting regarding whether to consent to the terms of use. In response to receiving a request, the server apparatus 30 updates the second setting according to the received request. For example, a screen that contains the text of the terms of use and a user interface for selecting “consent" or “non-consent" is displayed on an application installed on the terminal apparatus or on a website. When “consent" is selected at the first setting change, the value regarding the status of consent to the terms of use is changed from “not consented” to “consented” in the server apparatus 30. When “non-consent" is selected at the first setting change, the value regarding the status of consent to the terms of use is changed from “not consented” to “non-consent” in the server apparatus 30. At the second or subsequent setting change, when the “non- consent” is selected last time and “consent” is selected this time, the value regarding the status of consent to the terms of use is changed from “not consented” to “consented” in the server apparatus 30. At the second or subsequent setting change, when the “consent” is selected last time and “non-consent” is selected this time, the value regarding the status of consent to the terms of use is changed from “consented” to “non-consent” in the server apparatus 30.

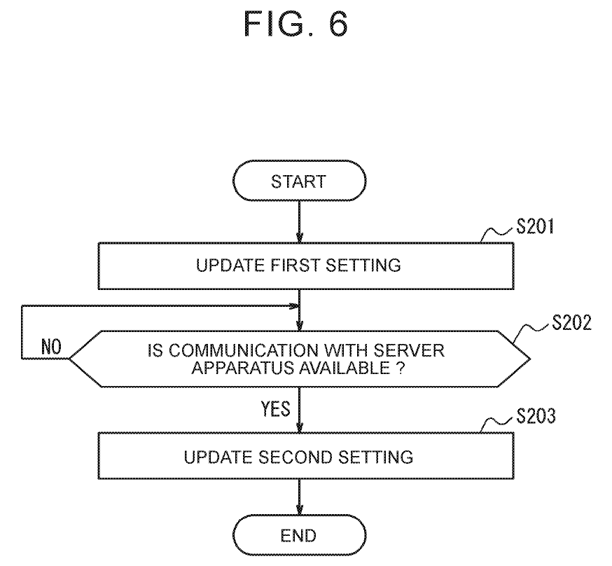

The additional operation of the information processing apparatus 20 according to the present embodiment will be described with reference to FIG. 6. The setting selection method according to the present embodiment can further include step S201, step S202, and step S203 shown in FIG. 6.

Step S201 is executed, for example, after the flow shown in FIG. 5 ends.

When the control unit 21 receives, in S201 via the input device 52, user input changing the setting regarding whether to consent to the terms of use, the control unit 21 updates the first setting with the changed setting in the storage unit 22. For example, the control unit 21 displays a screen similar to the first select screen on the display according to a request from the user 11, and receives, via the touch screen, touch input selecting “consent" or “non-consent”. The control unit 21 updates the value regarding the status of consent to the terms of use, included in the values of privacy settings stored in the nonvolatile memory, so as to match with the selected value.

Instead of user input changing the setting regarding whether to consent to the terms of use, user input designating a prohibited type may be received. In such an example, when the control unit 21 receives user input designating a prohibited type via the input device 52, the control unit 21 adds the setting for the prohibited type to the first setting in the storage unit 22. For example, the control unit 21 displays a screen similar to the second select screen on the display according to a request from the user 11, and receives, via the touch screen, touch input selecting “allowed" or “not allowed" for each item. The control unit 21 may receive touch input selecting “allowed" or “not allowed" only for items with differences in value. The control unit 21 updates the value regarding whether to allow transmission of personal information to the outside of the vehicle 50, included in the values of privacy settings stored in the nonvolatile memory, so as to match with the selected value.

After S201, step S202 is executed.

In S202, the control unit 21 determines whether communication with the server apparatus 30 is available, as in the case of step S102 shown in FIG. 5. When the control unit 21 determines that the communication unit 23 is available for communication with the server apparatus 30,step S203 is executed. On the other hand, when the control unit 21 determines that the communication unit 23 is not available for communication with the server apparatus 30, step S202 is executed again.

In S203, the control unit 21 transmits, to the server apparatus 30 via the communication unit 23, a request to update the second setting with the setting changed in S201. In response to receiving a request, the server apparatus 30 updates the second setting with the changed setting according to the received request. For example, the server apparatus 30 updates the value regarding the status of consent to the terms of use, included in the held values of privacy settings, so as to match with the value selected in S201.

When the control unit 21 receives user input designating a prohibited type instead of user input changing the setting regarding whether to consent to the terms of use in S201, the control unit 21 transmits, to the server apparatus 30 via the communication unit 23, a request to add the setting regarding the prohibited type to the second setting. In response to receiving a request, the server apparatus 30 adds the setting regarding the prohibited type to the second setting according to the received request. For example, the server apparatus 30 updates the value regarding whether to allow transmission of personal information to the outside of the vehicle 50, included in the held values of privacy settings, so as to match with the value selected in S201.

After S203, for example, the flow shown in FIG. 5 is executed again.

The disclosure is not limited to the above-described embodiment. For example, two or more blocks shown in the block diagram may be integrated or one block may be divided. Instead of executing two or more steps described in the flowchart in time sequence in accordance with the description, the steps may be executed in parallel or in different order in accordance with the processing capacity of an apparatus that executes the steps, or as needed. Modifications are possible without departing from the purport of the disclosure.

What is claimed is:

1. A vehicle configured to communicate with a server apparatus, the vehicle comprising:
a positioning device;
a microphone;
a camera;
a sensor;
a nonvolatile memory;
an input device; and
a computer configured to
store, in the nonvolatile memory, a first setting regarding whether to consent to terms of use,
collect two or more types of information among four types of information including location information, audio information, image information, and vehicle information respectively acquired through the positioning device, the microphone, the camera, and the sensor,
receive, from the server apparatus, a second setting regarding whether to consent to the terms of use,
determine whether a difference is present between the first setting stored in the nonvolatile memory and the second setting received from the server apparatus,
when the computer determines that a difference is present between the first setting and the second setting, receive, via the input device, user input selecting one of the first setting and the second setting and, based on the selected setting, determine whether a user consents to the terms of use, and
when the computer determines that the user consents to the terms of use, transmit the collected two or more types of information to the server apparatus in real time, excluding information of a prohibited type, the computer being prohibited from transmitting the information of the prohibited type to an outside of the vehicle.

2. An information processing apparatus installed in a vehicle, the information processing apparatus comprising:
a communication device configured to communicate with a server apparatus;
a memory storing a first setting regarding whether to consent to terms of use; and
a processor configured to
receive, from the server apparatus via the communication device, a second setting regarding whether to consent to the terms of use,
determine whether a difference is present between the first setting stored in the memory and the second setting received from the server apparatus,
when the processor determines that a difference is present between the first setting and the second setting, receive user input selecting one of the first setting and the second setting via an input device mounted on the vehicle and, based on the selected setting, determine whether a user consents to the terms of use, and
when the processor determines that the user consents to the terms of use, transmit, via the communication device, information collected in the vehicle to the server apparatus.

3. The information processing apparatus according to claim 2, wherein the processor is configured to:
in response to receiving, via the input device, user input changing a setting regarding whether to consent to the terms of use, update the first setting with the changed setting in the memory; and
when the communication device is available for communication with the server apparatus, transmit a request to update the second setting with the changed setting to the server apparatus via the communication device.

4. The information processing apparatus according to claim 2, wherein the processor is configured to, when the communication device is first available for communication with the server apparatus after startup, receive the second setting from the server apparatus via the communication device.

5. The information processing apparatus according to claim 2, wherein the processor is configured to
when the processor determines that a difference is present between the first setting and the second setting at a time point, ask the user which setting to select, via an output device mounted on the vehicle, and
in response to receiving, via the input device, not only user input selecting one of the settings but also user input requesting that the same selection be applied when a difference is present between the first setting and the second setting after the time point, apply the same selection without asking the user which setting to select even when the processor determines that a difference is present between the first setting and the second setting after the time point.

6. The information processing apparatus according to claim 2, wherein the processor is configured to
transmit, to the server apparatus via the communication device, a request to update the second setting with the first setting when the first setting is selected, and
when the second setting is selected, update the first setting with the second setting in the memory.

7. The information processing apparatus according to claim 2, wherein the processor is configured to determine, based on any one of the settings, whether the user consents to the terms of use, when the processor determines that no difference is present between the first setting and the second setting.

8. The information processing apparatus according to claim 2, wherein:
each of the first setting and the second setting includes a setting regarding a type of information prohibited from being transmitted to an outside of the vehicle; and
the processor is configured to
when the processor determines that a difference is present between the first setting and the second setting, identify, as a prohibited type based on a selected setting, the type of information prohibited by the user from being transmitted to the outside of the vehicle, and
when the processor determines that the user consents to the terms of use, transmit information collected in the vehicle, to the server apparatus via the communication device, excluding information of the identified prohibited type.

9. The information processing apparatus according to claim 8, wherein the processor is configured to:
in response to receiving user input designating the prohibited type via the input device, add a setting regarding the prohibited type to the first setting in the memory; and
when the communication device is available for communication with the server apparatus, transmit, to the server apparatus via the communication device, a request to add the setting regarding the prohibited type to the second setting.

10. The information processing apparatus according to claim 8, wherein the processor is configured to, when the processor determines that no difference is present between the first setting and the second setting, identify the prohibited type based on any one of the settings.

11. The information processing apparatus according to claim 8, wherein the information collected in the vehicle includes two or more types of information among four types of information including location information, audio information, image information, and vehicle information respectively acquired through a positioning device, a microphone, a camera, and a sensor mounted on the vehicle.

12. A system comprising:
the information processing apparatus according to claim 2; and
the server apparatus according to claim 2.

13. The system according to claim 12, wherein the server apparatus is configured to, in response to receiving a request to change a setting regarding whether to consent to the terms of use from a terminal apparatus associated with the user, update the second setting according to the received request.

14. A vehicle comprising the information processing apparatus according to claim 2.

15. A setting selection method that is executed by a processor of an information processing apparatus installed in a vehicle, the information processing apparatus including a communication device configured to communicate with a server apparatus, a memory storing a first setting regarding whether to consent to terms of use, and the processor, the setting selection method comprising:
receiving, from the server apparatus via the communication device, a second setting regarding whether to consent to the terms of use;
determining whether a difference is present between the first setting stored in the memory and the second setting received from the server apparatus;
when the processor determines that a difference is present between the first setting and the second setting, receiving user input selecting one of the first setting and the second setting via an input device mounted on the vehicle and, based on the selected setting, determining whether a user consents to the terms of use; and
when the processor determines that the user consents to the terms of use, transmitting, via the communication device, information collected in the vehicle to the server apparatus.

16. The setting selection method according to claim 15, further comprising:
in response to receiving, via the input device, user input changing a setting regarding whether to consent to the terms of use, updating the first setting with the changed setting in the memory; and
when the communication device is available for communication with the server apparatus, transmitting a request to update the second setting with the changed setting to the server apparatus via the communication device.

17. The setting selection method according to claim 15, further comprising, when the communication device is first available for communication with the server apparatus after startup of the processor, receiving the second setting from the server apparatus via the communication device.

18. The setting selection method according to claim 15, further comprising:
when the processor determines that a difference is present between the first setting and the second setting at a time point, asking the user which setting to select, via an output device mounted on the vehicle; and
in response to receiving, via the input device, not only user input selecting one of the settings but also user input requesting that the same selection be applied when a difference is present between the first setting and the second setting after the time point, applying the same selection without asking the user which setting to select even when the processor determines that a difference is present between the first setting and the second setting after the time point.

19. The setting selection method according to claim 15, further comprising:
when the processor determines that a difference is present between the first setting and the second setting, identifying, as a prohibited type based on a selected setting, a type of information prohibited by the user from being transmitted to an outside of the vehicle; and
when the processor determines that the user consents to the terms of use, transmitting information collected in the vehicle to the server apparatus via the communication device, excluding information of the identified prohibited type, wherein
each of the first setting and the second setting includes a setting regarding the type of information prohibited from being transmitted to the outside of the vehicle.

20. The setting selection method according to claim 19, further comprising:
in response to receiving user input designating the prohibited type via the input device, adding a setting regarding the prohibited type to the first setting in the memory; and
when the communication device is available for communication with the server apparatus, transmitting, to the server apparatus via the communication device, a request to add the setting regarding the prohibited type to the second setting.
